(19) United States
(12) Patent Application Publication
(10) Pub. No.: US 2013/0127838 A1
(43) Pub. Date: May 23, 2013

(54) SYSTEMS AND METHODS FOR PROVIDING A THREE-DIMENSIONAL DISPLAY OF A DIGITAL IMAGE

(71) Applicants: Michael Derrig, John's Island, SC (US); Hezzie Green, Charleston, SC (US); Denton Heaney, Charleston, SC (US); Kristian Millirons, John's Island, SC (US)

(72) Inventors: Michael Derrig, John's Island, SC (US); Hezzie Green, Charleston, SC (US); Denton Heaney, Charleston, SC (US); Kristian Millirons, John's Island, SC (US)

(73) Assignee: KIZ STUDIOS, Alpharetta, GA (US)

(21) Appl. No.: 13/474,537

(22) Filed: May 17, 2012

Related U.S. Application Data
(60) Provisional application No. 61/487,163, filed on May 17, 2011.

(51) Int. Cl. G06T 15/00

(52) U.S. Cl. CPC G06T 15/00
USPC 345/419

(57) ABSTRACT

The present invention describes a method for providing a three-dimensional display of a digital image. An exemplary embodiment of the present invention provides a method for providing a three-dimensional display of a digital image including retrieving of at least one digital image from a storage memory on an electronic device, wherein the digital image comprises at least two digital image layers. Additionally, displaying to a viewer the at least two digital image layers of the digital image. Moreover, estimating of a change in a perspective of the viewer by a three-dimensional parallax display module based on a plurality of spatial orientation data. Furthermore, modifying, with the three-dimensional parallax display module, the display of the at least two digital image layers.

### CROSS REFERENCE TO RELATED APPLICATIONS

This application claims priority of U.S. Provisional Patent Application No. 61/487,163 filed May 17, 2011, the entire contents and substance of which are hereby incorporated by reference.

### BACKGROUND

1. Field of the Invention

The present invention relates generally to the display of a three-dimensional (3D) digital image, and more specifically to method and device for performing display of a 3D digital image using motion.

2. Description of Related Art

A digital image is an electronically stored object that can be visually displayed. The use of digital images pervades the modern world. Pictures, for example, are no longer stored on physical albums but on digital albums. As a result, a morass of electronic devices capable of digital image display are available. Common electronic devices include, but are not limited to, the iPhone®, iPad®, iPod®, Blackberry®, Playbook®, smartphone, tablet PC, laptop, desktop, netbook, plasma TV, LCD display, projector, CRT, and video game counsels. However, despite an assortment of electronic devices capable of digital image display, these electronics display digital images via a two dimensional (2D) screen.

As the real world is 3D, there exists a desire to provide 3D digital images to 2D screens. Whereas 3D images are composed of a height, width, and depth, 2D images are composed of just a height and width. Since 2D screens—composed of just a height and width—cannot display a depth, a truly 3D digital image cannot be displayed. 2D screens are limited in that they can only display 2D images. In order to produce a 3D digital image, an illusion of depth must be created.

Traditional methods of creating an illusion of depth on a 2D plane have been known for quite some time. For example, objects farther away appear smaller than objects closer to the observer. For another example, when objects close to the observer are in focus, objects farther away appear fuzzy. The reverse is also true: when objects farther away from the observer are in focus, objects close to the observer appear fuzzy. For a further example, the colors of objects farther away appear less vibrant than those closer to the observer.

The same traditional methods of creating an illusion of depth on a 2D plane have been used on the 2D screens of an electronic device capable of digital image display. As a result, the resulting 3D digital image is static; the digital image does not change regardless of the position of the observer or position of an electronic device. For example, an observer standing to the right of a 2D screen, an observer standing to the left of a 2D screen, and an observer standing directly in front of a 2D screen all see the exact same image. The different vantage points of each observer in real life, however, produce varying perceptions of depth. The observer standing to the right of, left of, or directly in front of, say, a tree would each experience a different perception of depth.

In order to produce a more real 3D experience, a 3D digital image produced on a 2D screen must adjust depending on the observer's position relative to the screen. There is significant consumer demand to expand the availability of 3D digital images and the devices on which they can be displayed. Therefore, it would be advantageous to provide a method and device for providing 3D digital images that change based on the orientation of the user or an electronic device. Furthermore, it would be advantageous to provide a method and device for imparting three-dimensional quality to two-dimensional digital images for day-to-day electronic devices.

### BRIEF DESCRIPTION OF THE FIGURES

FIG. 1A provides an exemplary embodiment of a three-dimensional parallax display device 100 comprising a storage memory, display, and processor.

FIG. 1B provides an illustration of a block diagram of the method for providing a three-dimensional display of a digital image 190 in accordance with an exemplary embodiment of the present invention.

FIG. 2 provides an illustration of the multiple layers of digital image 105 in accordance with an exemplary embodiment of the present invention.

FIG. 3 provides an exemplary embodiment illustrating the altered arrangements multiple digital image layers partake depending upon viewer perspective.

FIGS. 4A-4F provides six exemplary embodiments of three-dimensional parallax display device 100.

FIG. 5 provides an illustration of digital image layer modification modified by a three-dimensional parallax display module.

FIG. 6 provides an exemplary embodiment of a three-dimensional digital image 105 resulting from an exemplary embodiment method for providing a three-dimensional display of a digital image 190.

### BRIEF SUMMARY OF THE INVENTION

The present invention describes a method for providing a three-dimensional display of a digital image. An exemplary embodiment of the present invention provides a method for providing a three-dimensional display of a digital image including retrieving of at least one digital image from a storage memory on an electronic device, wherein the digital image comprises at least two digital image layers. Additionally, displaying to a viewer the at least two digital image layers of the digital image. Moreover, estimating of a change in a perspective of the viewer by a three-dimensional parallax display module based on a plurality of spatial orientation data. Furthermore, modifying, with the three-dimensional parallax display module, the display of the at least two digital image layers.

In addition to method for providing a three-dimensional display of a digital image, the present invention provides a three-dimensional parallax display device. An exemplary embodiment of a three-dimensional parallax display device that includes an electronic device comprising a processor, a storage memory, and a display for displaying one or more digital images, wherein each digital image is comprised of at least two digital image layers. Additionally, three-dimensional parallax display module enabled to analyze a plurality of spatial orientation data and enabled to modify the display of the at least two digital image layers.

These and other objects, features, and advantages of the present invention will become more apparent upon reading the following specification in conjunction with the accompanying drawing figures.

### DETAILED DESCRIPTION

The present invention addresses the deficiencies in the prior art concerning the display of three-dimensional digital images. Specifically, the present invention provides systems and methods for providing effective and efficient display of three-dimensional images. A three-dimensional digital image display provided in accordance with the present invention is enabled to impart a perceived three-dimensional quality to otherwise two-dimensional digital images. Additionally, the present invention overcomes the drawbacks of conventional methods and systems in the prior art and provides systems and methods enabled to impart three-dimensional quality to digital images for a broad spectrum of electronic devices.

The present invention describes a method for providing a three-dimensional display of a digital image. An exemplary embodiment of the present invention provides a method for providing a three-dimensional display of a digital image including retrieving of at least one digital image from a storage memory on an electronic device, wherein the digital image comprises at least two digital image layers. Additionally, displaying to a viewer the at least two digital image layers of the digital image. Moreover, estimating of a change in a perspective of the viewer by a three-dimensional parallax display module based on a plurality of spatial orientation data. Furthermore, modifying, with the three-dimensional parallax display module, the display of the at least two digital image layers.

In addition to method for providing a three-dimensional display of a digital image, the present invention provides a three-dimensional parallax display device. An exemplary embodiment of a three-dimensional parallax display device that includes an electronic device comprising a processor, a storage memory, and a display for displaying one or more digital images, wherein each digital image is comprised of at least two digital image layers. Additionally, three-dimensional parallax display module enabled to analyze a plurality of spatial orientation data and enabled to modify the display of the at least two digital image layers.

Additional to a method for providing a three-dimensional display of a digital image and a three-dimensional parallax display device, the present invention provides a three-dimensional parallax display system. An exemplary embodiment of a three-dimensional parallax display system including a display for displaying one or more digital images, wherein each digital image is comprised of at least two digital image layers. Moreover, a three-dimensional display processing unit enabled to modify the display of the at least two digital image layers, wherein modification of the one or more digital image layers is dependent upon a plurality of spatial orientation data.

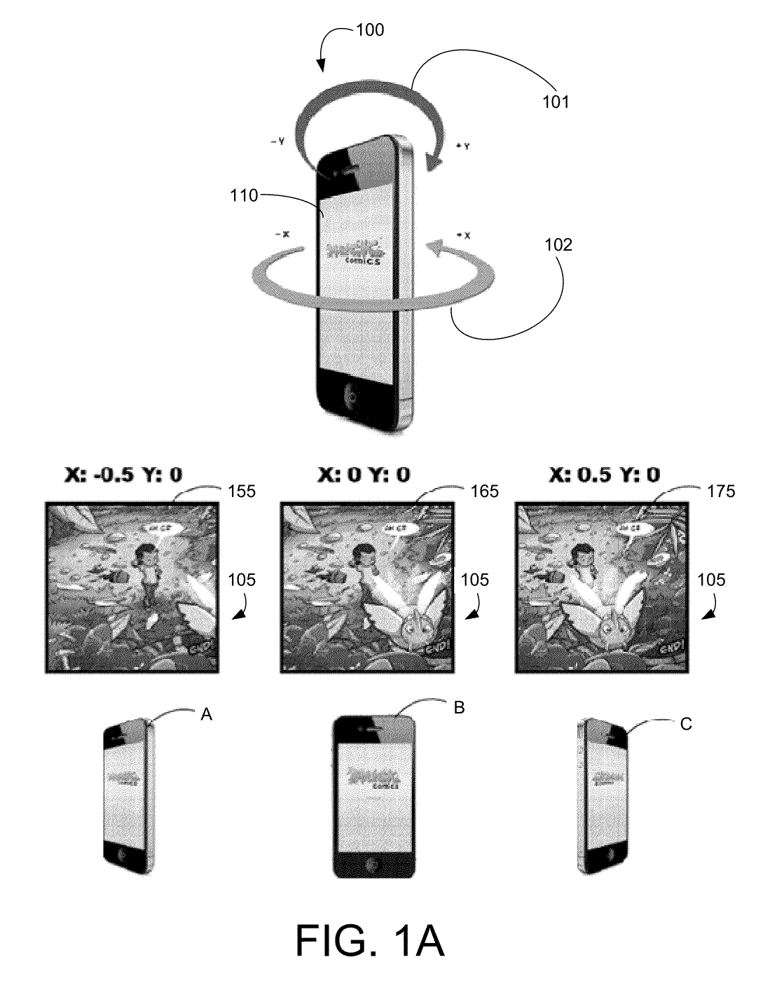

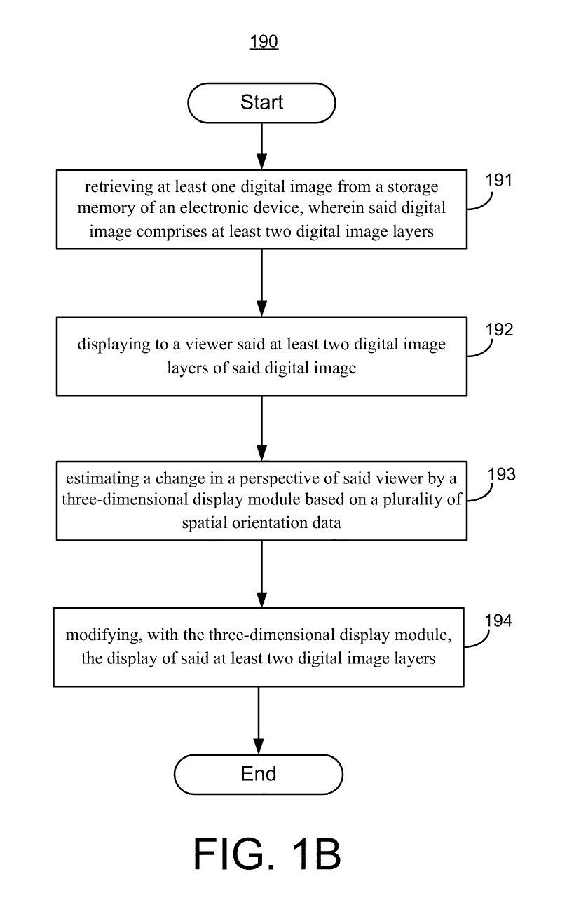

FIG. 1A provides an exemplary embodiment of three-dimensional parallax display device 100 comprising a storage memory, display, and processor, wherein the processor is enabled to run a three-dimensional parallax display module. In exemplary embodiment of the three-dimensional parallax display device 100 shown in FIG. 1A, the device 100 is enabled to retrieve at least one digital image from a storage memory. In an exemplary embodiment, the storage memory may take on a virtual or physical form. In this exemplary embodiment, virtual storage memory allows a digital image to be retrieved via landline, wireless network, cellular network, Bluetooth, or other non-physical storage means. In another exemplary embodiment, physical storage memory allow a digital image to be retrieved via Universal Serial Bus (USB) flash drive, external data storage unit, Subscriber Identity Module (SIM) card, internal storage unit, or other physical storage means. Those skilled in the art will appreciate that there are a variety of different ways to retrieve one, or more, digital images from the storage memory of an electronic device.

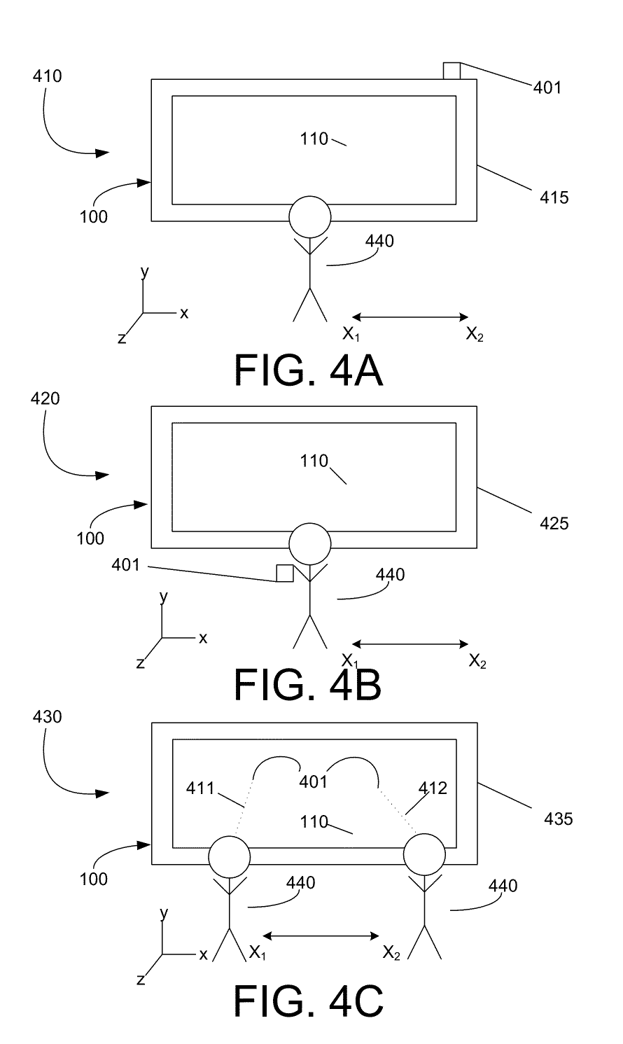

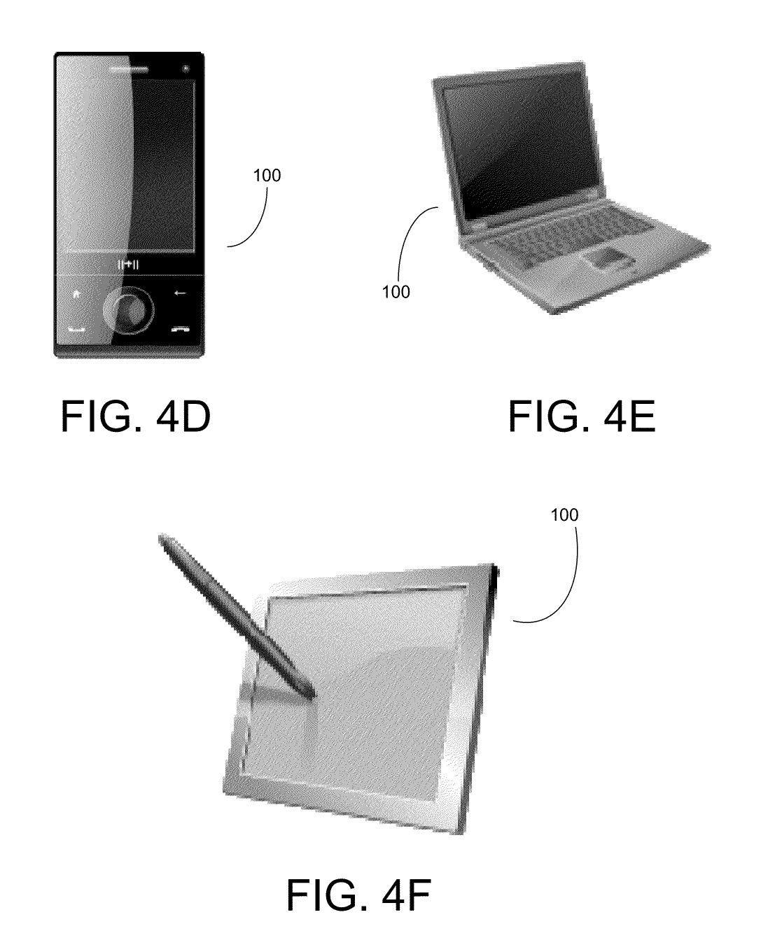

The display for the electronic device displays one or more digital images retrieved from storage memory. The display may take on many forms. For example, and not limitation, an exemplary embodiment of display 110 for a three-dimensional parallax display device 100 is the screen of a smartphone, as illustrated in FIG. 1A. Further exemplary embodiments of display 110 for a three-dimensional parallax display device 100 are illustrated as a television screen in FIG. 4A-C, a MP3 player screen in FIG. 4D, a computer screen in FIG. 4E, and a tablet screen in FIG. 4F. Examples, and not limitations, of display 110 components for a three-dimensional parallax display device 100 can include cathode ray tube (CRT), liquid crystal display (LCD), light emitting diode (LED), plasma, and rear projection (RP). Those skilled in the art will appreciate that a display for one or more digital images can be any electronic display.

FIG. 1A further illustrates an exemplary embodiment of a processor of a three-dimensional parallax display device 100. The processor is equipped with a three-dimensional parallax display module enabled to analyze spatial orientation data and enabled to modify the display of a digital image. The exemplary embodiment of the three-dimensional parallax display device 100 shown in FIG. 1A is a smartphone having a processor. However, those of skill in the art will appreciate that many embodiments a three-dimensional parallax display device 100 processor are possible. For example, and not limitation, a processor of the three-dimensional parallax display device 100 may be embodied as a television, a video game console, MP3 player, computer, or tablet such as the various exemplary embodiments of three-dimensional parallax display device 100 shown in FIGS. 4B and 4C, 4A, 4D, 4E, and 4F, respectively. Those skilled in the art will appreciate that a three-dimensional parallax display module can be equipped on any electronic device processor.

In exemplary embodiment of the three-dimensional parallax display device 100, the three-dimensional parallax display module executing on the processor can retrieve a digital image 105 from a storage memory on the device 100. Those of skill in the art will appreciate that in alternative embodiments, the three-dimensional parallax display module works in conjunction with one or more other modules, such as an image processing module, on the device 100. The three-dimensional parallax display module executing on the processor of an exemplary embodiment of the three-dimensional parallax display device 100 can analyze a plurality of spatial orientation data received from rotation along y-axis 101 and rotation along x-axis 102. In an exemplary embodiment, the three-dimensional parallax display module can modify a digital image 105 based on analyzed spatial orientation data. In exemplary embodiment 100, the display 110 of three-dimensional parallax display device 100 displays modified digital image 105.

In an exemplary embodiment of the three-dimensional parallax display device 100, at least one digital image layer the digital image 105 is modified to create the effect of a three-dimensional display. For example, not limitation, when rotated as shown in perspective A of FIG. 1A, the three-dimensional parallax display device 100 receives spatial orientation data of X=−0.5, and the three-dimensional parallax display module modifies at least one digital image layer of digital image 105 accordingly to create the effect of a three-dimensional display as shown in perspective 155 of digital image 105. When rotated by amount as shown in perspective B of FIG. 1A, three-dimensional parallax display device 100 receives spatial orientation data of X=0, and the three-dimensional parallax display module modifies the at least one digital image layer of digital image 105 accordingly to create the effect of a three-dimensional display as shown in perspective 165 of digital image 105. When rotated by amount as shown in perspective C of FIG. 1A, three-dimensional parallax display device 100 receives spatial orientation data of X=0.5, and the three-dimensional parallax display module modifies the at least one digital image layer of digital image 105 accordingly to create the effect of a three-dimensional display as shown in perspective 175 of digital image 105.

Therefore, in the exemplary embodiment of the three-dimensional parallax display device 100 shown in FIG. 1A, spatial orientation data can be assigned a positive value, a zero value, and/or a negative value on the xy coordinate plane. Additionally, as exemplified, not limited, spatial orientation data can be assigned a whole or fractional value. Furthermore, in exemplary embodiment 100, spatial orientation data is received by three-dimensional parallax display device 100 for motion along x-axis 102 and y-axis 101, where Y=0 for perspectives A, B, and C since no rotation occurs. Additional examples, and not limitations, of spatial orientation data can occur along an x-axis, y-axis, z-axis, plane defined by two axes, and three dimensions. Furthermore, as examples, and not limitations, spatial orientation data can estimate motions of translation, rotation, pitch, yaw, and roll. It will be apparent to those skilled in the art that spatial orientation data can also be collected from one axis or in all three dimensions.

In exemplary embodiment of the three-dimensional parallax display device 100, spatial orientation data is detected, estimated, or collected via an accelerometer of a smartphone. In other exemplary embodiments, spatial orientation data can be detected, estimated, or collected from an electronic device equipped with a global position system (GPS), gyroscope, webcam, electromagnetic sensor (e.g., infrared and laser), or other sensor capable of providing, receiving, or calculating, either directly or indirectly, spatial orientation data. Those skilled in the art will appreciate that spatial orientation data can be obtained or estimated by a variety of different hardware and software techniques.

One significant benefit of an exemplary embodiment of the three-dimensional parallax display device 100 is that the digital image 105 can be displayed on a broad spectrum of electronic devices, including, but not limited to, everyday devices not specifically manufactured to display three-dimensional images. The method and devices for displaying three-dimensional digital image 105 requires only spatial orientation data. Spatial orientation data can be collected through many forms, as discussed above. Therefore, for example only, and not limitation, the devices and method for providing a three-dimensional display of a digital image can be provided to devices including, but not limited to, iPhone®, iPad®, Blackberry®, Playbook®, smartphone, tablet PC, laptop, netbook, desktop, plasma TV, LCD display, projector, CRT, video game counsels, video game counsel controller, camera, or other display device. Those skilled in the art will appreciate that a three-dimensional parallax display device 100 can be embodied in any electronic device comprising a storage memory, display, and processor.

FIG. 1B provides an illustration of a block diagram of the method for providing a three-dimensional display of a digital image 190 in accordance with an exemplary embodiment of the present invention. An exemplary embodiment of a method for providing a three-dimensional display of a digital image 190, as shown in FIG. 1B, illustrates first step 191 involves retrieving at least one digital image from a storage memory of an electronic device, wherein the digital image comprises at least two digital image layers. In an exemplary embodiment of the method for providing a three-dimensional display of a digital image 190, the retrieval of a digital image can occur through many means, including, but not limited to, wirelessly or physically. Wireless means of retrieving a digital image can occur via a Wi-Fi network, cellular network, Bluetooth, or other wireless means. Physical means of retrieving a digital image can occur via Universal Serial Bus (USB) flash drive, external data storage unit, Subscriber Identity Module (SIM) card, or other physical means. Those skilled in the art will appreciate that there are a variety of different ways to retrieve one, or more, digital images on an electronic device. Additionally, the digital image can be stored in any type of storage memory that can retain a digital image, such as non-volatile and volatile memory.

The exemplary embodiment of the method for providing a three-dimensional display of a digital image 190 assumes a digital image is correctly retrieved from storage memory. In step 191, the method for providing a three-dimensional display of a digital image 190 does not necessarily require digital image 105 be stored in storage memory for a prolonged period of time. In one embodiment the method for providing a three-dimensional display of a digital image 190 can involve retrieval of a digital image from a temporary storage memory. In one embodiment of the method for providing a three-dimensional display of a digital image 190, the digital image can be retrieved from the random-access memory (RAM) of a computer. In another exemplary embodiment, a digital image can be accessed from the internet, temporarily stored on virtual memory, and immediately retrieved. In a further exemplary embodiment, the buffering of streaming video constitutes retrieval of at least one digital image from storage memory. Additionally, one exemplary embodiment allows the retrieval of a digital image at any point during the operational lifetime of the method for providing a three-dimensional display of a digital image 190. Furthermore, in another exemplary embodiment, the electronic device can receive more than one image at one time. For example, and not limitation, the plurality of digital images can be used to compose Comic Books, Trading Cards, Advertisements, Books, Photo, Maps, Weather Maps, video games, or movies. Those skilled in the art will appreciate that retrieving at least one digital image from a storage memory can occur through many means.

Step 192 of the exemplary embodiment of the method for providing a three-dimensional display of a digital image 190 involves displaying to a viewer the at least two digital image layers of the digital image. Similarly, the third step 193 of exemplary embodiment of a method for providing a three-dimensional display of a digital image 190 involves estimating a change in a perspective of the viewer by a three-dimensional parallax display module based on a plurality of spatial orientation data. The fourth step 194 of exemplary embodiment of a method for providing a three-dimensional display of a digital image 190 involves modifying, with the three-dimensional parallax display module, the display of the at least two digital image layers. The exemplary embodiment of the method for providing a three-dimensional display of a digital image 190 enables electronic device to display an apparent three-dimensional image from a two-dimensional digital image. Therefore, implementing the exemplary embodiment of the method for providing a three-dimensional display of a digital image 190 illustrated in FIG. 1B enables conversion of a previously two-dimensional digital image into a three-dimensional digital image through special orientation data. Furthermore, the exemplary embodiment of the method for providing a three-dimensional display of a digital image 190 enables viewers to specifically design a digital image solely for the purpose of three-dimensional digital image display. For example, and not limitation, an artist can prepare and design a three-dimensional digital Comic Book series to be displayed using the method for providing a three-dimensional display of a digital image 190.

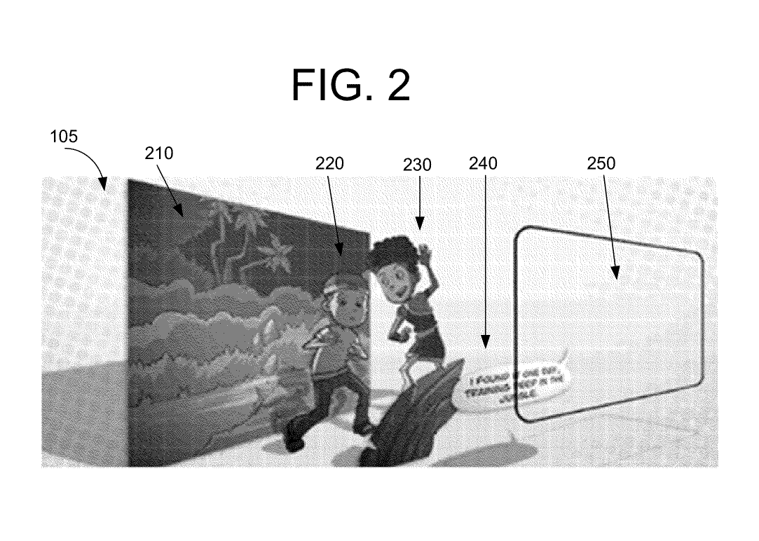

FIG. 2 provides an illustration of the multiple layers of digital image 105 in accordance with an exemplary embodiment of the present invention. In an exemplary embodiment, digital images can be electronic snapshots or recordings, such as that of a scene, scanned document, artistic work, or other photograph. For example only, and not limitation, digital images can include, but are not limited to, pictures, drawings, artist renderings, electronic text, scanned images, scanned documents, and other visual recordings, such as videos and movies. Those of skill in the art will appreciate that a digital image can be any graphical display. FIG. 2 illustrates in an exemplary embodiment of digital image 105 two cartoon characters in a forest.

Furthermore, exemplary embodiment digital image 105 can comprise multiple layers. In an exemplary embodiment, digital image layers can be stacked on top and behind of other layers. An exemplary embodiment of digital image 105, as seen in FIG. 2, demonstrates digital image 105 discerned into five layers: layers 210, 220, 230, 240, and 250. In this exemplary embodiment of digital image 105, the priority of a layer in a stack is known as depth order: the higher the depth order, the greater the priority. For example, and not limitation, the exemplary embodiment of digital image 105 has a depth order from back to front, relative to viewer, starting with layer 210 and ending with layer 250. In this exemplary embodiment, layer 210 is a forest background digital image layer and has the lowest depth order. Furthermore, in this exemplary embodiment, all other layers, layers 220-250, stack on top of layer 210. In this exemplary embodiment, layer 220 has a depth order higher than that of 210. Therefore, in this exemplary embodiment, layer 220 stacks on top of 210. Layer 230, in this exemplary embodiment, has a greater depth order than layer 210 and layer 220. Thus, in this exemplary embodiment, layer 230 stacks above layer 210 and layer 220. As a result, in this exemplary embodiment, layer 220 is packed between layers 210 and 230. The same logic follows for layer 240 and 250 in this exemplary embodiment. In this exemplary embodiment, illustrated in FIG. 2, five digital image layers, layers 210-250, are created. However, those of skill in the art will appreciate that a digital image can comprise of any number of digital image layers.

In addition, in another exemplary embodiment, the layers of digital image 105 can be pre-determined, or the layers of a digital image can be simultaneously retrieved and determined. As a result, the exemplary embodiment of the method for providing a three-dimensional display of a digital image 190 can be conducted on digital image 105 specifically created for this method for providing a three-dimensional display of a digital image 190 and/or for another exemplary embodiment of digital image 105 created for traditional two-dimensional viewing. For example, but not limitation, in one exemplary embodiment, a children's picture book, originally drawn for two-dimensional viewing, can be converted into multiple layers based upon outline detection or some other program or software. Once the layers have been determined in this exemplary embodiment, the method for providing a three-dimensional display of a digital image 190 can be used to impart three-dimensional quality to digital image 105 originally intended for two-dimensional viewing.

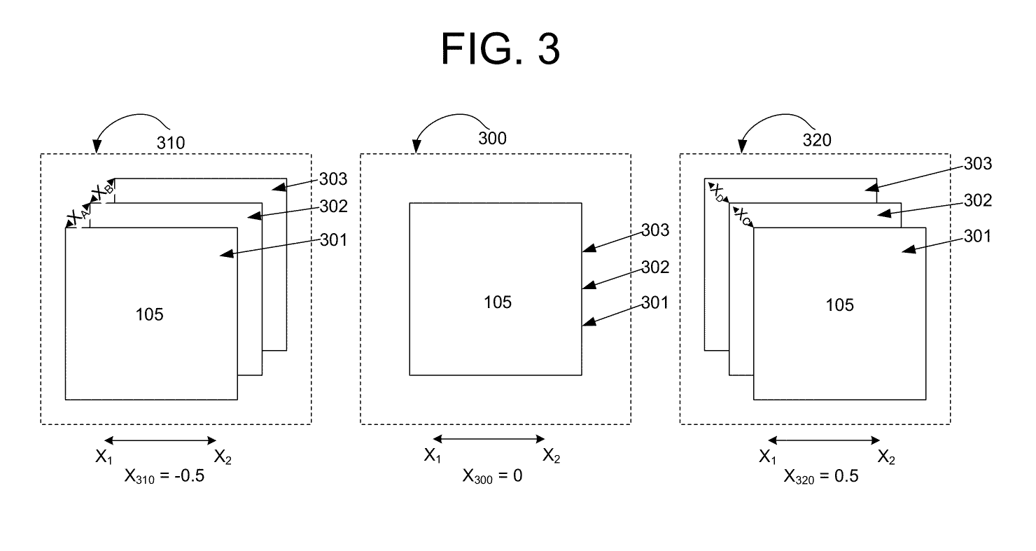

FIG. 3 provides an exemplary embodiment illustrating the altered arrangements multiple digital image layers partake depending upon viewer perspective. The method for providing a three-dimensional display of a digital image 190 can, in an exemplary embodiment, impart apparent three-dimensional quality to a two-dimensional image by modifying the arrangement of digital image layers. In one exemplary embodiment, the modification of digital image layers of digital image 105 occurs in attempt to emulate a change in viewer perspective as a result of spatial orientation. For example, and not limitation, in one exemplary embodiment, objects farther away from a viewer appear smaller than objects closer to the observer. In another exemplary embodiment, if objects close to a viewer are in focus, objects farther away appear fuzzy. Additionally, in another exemplary embodiment, objects closer to viewer appear to translate more than objects farther from the viewer when the viewer moves. In a further exemplary embodiment, colors of objects farther away appear less vibrant than those closer to the viewer. Those of skill in the art will appreciate that there are many methods of manipulating a digital image to reflect a change in viewer perspective based spatial orientation of the viewer.

In an exemplary embodiment, a two-dimensional digital image 105 comprises of data stored in pixels set in a two-dimensional array. In this exemplary embodiment, by partitioning digital image 105 into multiple digital layers, the method for providing a three-dimensional display of a digital image 190 can provide a three-dimensional parallax display 100. Specifically, in this exemplary embodiment, a two dimensional digital image 105 contains data stored in the xy-plane. By partitioning, modifying, and displaying multiple the digital image layers of this exemplary embodiment, the method for providing a three-dimensional display of a digital image 190 creates an apparent depth, a “z-dimension” to the xy-plane.

FIG. 3 illustrates an exemplary embodiment of digital image 105, which is represented by the solid square box and is composed of three digital image layers: layers 301, 302, and 303. In this exemplary embodiment, layers 301, 302, and 303 can be arranged in many orientations depending on the desired display. In this exemplary embodiment, viewer perspectives 300, 310, and 320 are illustrated by dotted square boxes. In this exemplary embodiment, perspective 300 represents a perspective of the digital image where the viewer and electronic device displaying the digital image are on parallel planes, and the viewer perceives the digital image in a perpendicular fashion. In exemplary embodiment of perspective 300, method for providing a three-dimensional display of a digital image 190 stacks layers 301, 302, and 303 directly on top of one another.

In other exemplary embodiments, perspectives 310 and 320 represent a view of the digital image where the viewer and three-dimensional parallax display 100 displaying digital image 105 are on non-parallel planes, and the viewer perceives the digital image at some angle away from the perpendicular. In an exemplary embodiment, a viewer perspective that moves in the direction of x₁—i.e., to the left of the perpendicular—has a perspective of 310, where layers 301, 302, and 303 are translated and stacked in a direction corresponding to an estimated change in perspective for the viewer. In this exemplary embodiment, the spatial orientation data X₃₁₀ is assigned a value of −0.5 and the digital image layers are translated by a custom amount of X_{A} and X_{B}. Similarly, in another exemplary embodiment, a viewer perspective that moves in the direction of x₂—i.e., to the right of the perpendicular—has a perspective of 320, where layers 301, 302, and 303 are translated and stacked in a direction corresponding to an estimated change in perspective for the viewer. In this exemplary embodiment, the spatial orientation data X320 is assigned a value of 0.5 and the digital image layers are translated by a custom amount of X_{C} and X_{D}, corresponding to an estimated change in perspective by the viewer.

In an exemplary embodiment, the amount and degree of modification is determined by a custom value determined by the nature of the digital image layer. In the exemplary embodiment of FIG. 3, the translation amounts are X_{A}, X_{B}, X_{C}, and X_{D}, where each represents a custom value for modification. In this exemplary embodiment, each value can be different, the same, or customarily set. For example, and not limitation, in this exemplary embodiment, layer 240 is composed of text and is given a custom value that results in little or no change in translation. As a result, in this exemplary embodiment, the text will not change position and can be easily read. Additionally, in another exemplary embodiment, the custom value for modification is based upon the perceived distance of a digital image layer. Therefore, in an exemplary embodiment, a background layer is given a custom value for modification that results in less translation than that of a foreground layer, since objects further from the viewer translate less than objects closer to the viewer.

Exemplary embodiments 310 and 320 illustrate translations of the digital image layers by a custom amount of X_{A-D} in a direction of X₁ or X₂. However, in other exemplary embodiments, other forms of digital image layer modification may occur. In other exemplary embodiments, digital image layers may be modified by translation in any of the six degrees of freedom (i.e., pitch, roll, etc.). Furthermore, in other exemplary embodiments, digital image layers can be modified in other fashions besides translation. In these exemplary embodiments, digital image layers can be modified by, and in any combination of, transparency, bleed amount, resistance, color change, noise reduction, rotation, reflection, and cropping. Those of skill in the art will appreciate that digital image layers can be modified by many methods.

Additionally, in exemplary embodiments 310 and 320, digital image layer stack is modified based upon viewer perspective change along the x-axis. Specifically, in exemplary embodiments 310 and 320, values of −0.5 and 0.5 are assigned to spatial orientation data variables X₃₁₀ and X₃₂₀. However, in other embodiments of this invention, digital image layer stack can be modified based upon viewer perspective along any axis, whether x, y, z, or any combination thereof. Furthermore, in this exemplary embodiment, digital image layer stack is modified in only one direction, specifically along the x-axis. However, in other embodiments, digital image layer stacks can be modified in multiple directs in a single modification. Additionally, in exemplary embodiments 300, 310 and 320, positive, negative, zero, and fractional values are assigned to spatial orientation data variables. In other embodiments, method for providing a three-dimensional display of a digital image 190 can assign values of consisting of natural, rational, and irrational numbers. Those of skill in the art will appreciate that any number and form of modification values can be assigned to spatial orientation variables.

FIGS. 4A-E provides five exemplary embodiments of three-dimensional parallax display device 100 enabled to receive spatial orientation data. For example, and not limitation, exemplary embodiments 410, 420, and 430 illustrate three example situations, not limitations. In the exemplary embodiment shown in FIG. 4A, the stationary electronic device 415 is equipped with sensor 401 to detect, estimate, or collect spatial orientation data between stationary electronic device 415 and viewer 440 along X₁ and X₂. The spatial orientation data from this exemplary embodiment is then input into the three-dimensional parallax display module of stationary electronic device 415. In an exemplary embodiment of the three-dimensional parallax display 100 shown in FIG. 4A, the electronic device is a stationary television mounted with a digital recording device capable of collecting spatial orientation data and transmitting the data to the three-dimensional parallax display 100. Other exemplary embodiment of a three-dimensional parallax display 100 show in FIG. 4A is a stationary computer or laptop equipped with a webcam to detect spatial orientation of viewer 440 relative to the computer or laptop.

In exemplary embodiment shown in FIG. 4B, the stationary electronic device 425 is connected, either physically, wirelessly, or some other manner, to controller/detector 401 to detect, estimate, or collect spatial orientation data between station electronic device 425 and viewer 440 along X₁ and X₂. In this exemplary embodiment, the spatial orientation data is then transmitted or otherwise input into the three-dimensional parallax display module of the station electronic device 425. In an exemplary embodiment of the three-dimensional parallax display 100 shown in FIG. 4B, the electronic device is a stationary television equipped with a controller to transmit spatial orientation data to the three-dimensional parallax display module of a stationary television. An additional exemplary embodiment of controller 401 as shown in FIG. 4B is a gaming console controller, such as an X-Box®, Playstation®, or Nintendo Wii®, where viewer 440 equipped with controller/detector 401 provides spatial orientation data to the Nintendo Wii® console, which then inputs data to stationary electronic device 425 display. Therefore, in an exemplary embodiment, the electronic device for a three-dimensional parallax display 100 need not directly receive spatial orientation data. In an additional exemplary embodiment, the electronic device need not directly modify the received digital image. Instead, in this exemplary embodiment, a separate electronic device contains the three-dimensional parallax display module. Therefore, in this exemplary embodiment, digital image 105 and/or spatial orientation data are retrieved, received, and/or modify by a three-dimensional parallax display system.

In the exemplary embodiments shown in FIGS. 4A and 4B, the three-dimensional parallax display 100 takes the form of a three-dimensional parallax display system. In the exemplary embodiment of three-dimensional parallax display 100 illustrated in FIG. 1A, the three-dimensional parallax display 100 is a single device, such as a smartphone. However, in other embodiments, the three-dimensional parallax display 100 operates through a plurality of electronic devices, where at least one device comprises a processor, storage memory, or display.

In exemplary embodiment shown in FIG. 4C, stationary electronic device 435 is equipped with a sensor 401 to detect, estimate, or collect spatial orientation data between station electronic device 435 and line of sight 411 and 412 of viewer 440. In this exemplary embodiment, as viewer 440 changes perspective from X₁ to X₂, the line of sight for viewer 440 changes from 411 to 412, respectively. In this exemplary embodiment, sensor 401 detects and transmits this change of perspective to the three-dimensional parallax display module of stationary electronic device 435 in the form of spatial orientation data. In an exemplary embodiment of the three-dimensional parallax display 100 shown in FIG. 4C, the electronic device is a computer monitor equipped with eye-tracking technology. In this exemplary embodiment, the eye-tracking technology enables stationary electronic device 435 to receive spatial orientation data through a three-dimensional parallax display module. Thus, in this exemplary embodiment, sensor 401 need not be a separate electronic entity from an electronic device, such as that of exemplary embodiments 415 and 425.

All three exemplary embodiments of stationary electronic devices enabled to receive spatial orientation data are demonstrated in one axis, the x-axis. However, it will be apparent to those skilled in the art that spatial orientation data can be collected from one axis, one plane, or in all three dimensions. In the exemplary embodiment of receiving spatial orientation data from one axis, such as those provided in FIG. 4A-C, spatial orientation data can be collected from the x-axis, y-axis, z-axis, or some combination thereof. In the exemplary embodiment of receiving spatial orientation data from one plane, the data maybe collected from the xy-plane, yz-plane, xz-plane, or some combination thereof. In the exemplary embodiment of receiving spatial orientation data from three dimensions, the data collects lateral movement, vertical movement, depth movement, and/or some combination thereof. Furthermore, in another exemplary embodiment, spatial orientation data can be pre-received. For example, not limitation, in one exemplary embodiment, an amusement ride along a set track and set speed can be equipped with pre-received spatial orientation data. Therefore, in this exemplary embodiment, spatial orientation data need not be collected immediately before modification.

FIGS. 4D, 4E, and 4F illustrate, for example only, and not limitation, various embodiments of three-dimensional parallax display device 100. FIG. 4D provides an exemplary embodiment of a three-dimensional parallax display device 100 in the form of a portable music player equipped with display 110. FIG. 4E provides another exemplary embodiment of a three-dimensional parallax display device 100 in the form of a laptop computer. FIG. 4F provides a further exemplary embodiment of a three-dimensional parallax display device 100 in the form of a tablet computer. Those of skill in the art will appreciate that a three-dimensional parallax display device 100 can be any electronic devices equipped with a processor, storage memory, and display.

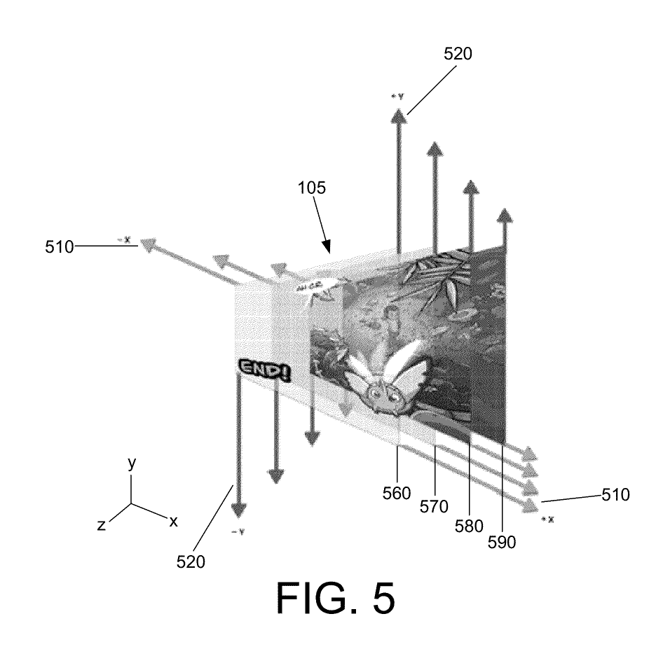

FIG. 5 provides an illustration of digital image layer modification modified by a three-dimensional parallax display module. In the exemplary embodiment shown in FIG. 5, digital image 105 is comprised of four layers, layers 560, 570, 580, and 590. In this exemplary embodiment, layer 560 contains the texts “ENDS!” and the quote bubble; layer 570, the insect; layer 580, the shrubbery; and layer 590, the background containing the character. Each layer of this exemplary embodiment can be translated along the x-axis, element 510, and along the y-axis, element 520.

In this exemplary embodiment, translation 510 and 520 can be along the x-axis and y-axis, respectfully. Translation is the movement of every pixel in an equal and specified direction. Translation, in this exemplary embodiment, cannot occur along the z-axis, because digital image 105 is composed of only a two-dimensional array of pixels. However, in this exemplary embodiment, the partitioning of digital image 105 into layers 560-590 impart apparent translation along the z-axis, as the addition of layers add apparent depth to digital image 105. As a result of the nature of translation in this exemplary embodiment, translation can move one or more pixels of digital image 105 off the display screen.

The bleed amount is the amount of image pixel data off the display screen. In other words, the bleed amount is the pixels in excess of the images rendered draw space, which will be the cropped portion of the image. In some embodiments, the bleed amount is necessary to determine, because without the bleed amount, essential portions of a digital image layer can be cropped unintentionally. For example only, and not limitation, in FIG. 1A and FIG. 5, exemplary embodiments 155, 165, and 175 illustrate insect in digital image 105 of layer 570. In this exemplary embodiment, the insect of digital image 105 and digital image layer 570 is cropped off the display in exemplary embodiment 155. However, in exemplary embodiment 165, the insect of digital image 105 and digital image layer 570 is fully visible on the display. The motion of the insect in this exemplary embodiment imparts apparent three-dimensionality to digital image 105. However, text, as illustrated in exemplary embodiments 555, 565, and 575 and digital image layer 560, resists translation.

Resistance is a value given to each layer of an image. For example only, not limitation, in an exemplary embodiment, layer 560 is given high resistance value, while layer 570 has a lower resistance value. Resistance, in this exemplary embodiment, prevents the text from being cropped. Additionally, in this exemplary embodiment, resistance maintains the positioning of text containing layer 560, which ensures the text remains in the same, or nearly the same, position to allow for easier reading. Furthermore, in this exemplary embodiment, resistance determines the mobility of layers. For example, not limitation, in this exemplary embodiment, insect of digital image 105 of layer 570 has a low resistance value. In this exemplary embodiment, the low resistance value allows high translation of the layer. The translation, therefore, in this exemplary embodiment, imparts a greater appearance of depth. It will be apparent to those skilled in the art that the resistance value can be determined through many variables.

The three-dimensional parallax display module is enabled to estimate a change in perspective of the viewer 440 by analyzing a plurality of spatial orientation data collected by the three-dimensional parallax display 100. Analysis of the spatial orientation data can take on many forms. In an exemplary embodiment, the three-dimensional parallax display module receives spatial orientation data from an accelerometer. In this exemplary embodiment, the three-dimensional parallax display module uses data from an accelerometer to modify at least one digital image layer. The three-dimensional parallax display module, in this exemplary embodiment, then displays the at least one digital image layer. Those of skill in the art will appreciate that the three-dimensional parallax display module can be found in many forms in many electronic devices. Those of skill in the art will also appreciate that the three-dimensional display digital module can operate in a variety of fashions.

Many digital image modification techniques are available and well known to one skilled in the art. In one exemplary embodiment, transparency is a modification factor for digital images 105. In this exemplary embodiment, full transparency, or 100% transparency, imparts invisibility to a layer. Therefore, in this exemplary embodiment, no transparency, or 0% transparency, masks all other layers. In other embodiments, digital image 105 may be modified by techniques that include, but are not limited to: selection, size alteration, noise reduction, histogram, color change, image orientation, distortion, enhancement, sharpening, and brightening.

In another exemplary embodiment, the amount of translation applied to each image layer is determined by subtracting the product of the bleed amount of the image, the resistance, and the ratio of acceleration from the registration of the image in two dimensional space (x,y coordinate space). In this exemplary embodiment, the resistance is determined by the depth order of the image within the stack, back to front, divided by the total number of images in the stack plus one and multiplied by a custom value determined by the application (to allow for custom resistance within certain images). The ratio of acceleration provided by the device in this exemplary embodiment is a 3D vector value of −1 to 1 within x,y,z coordinate space representing the physical rotational axis of the device.

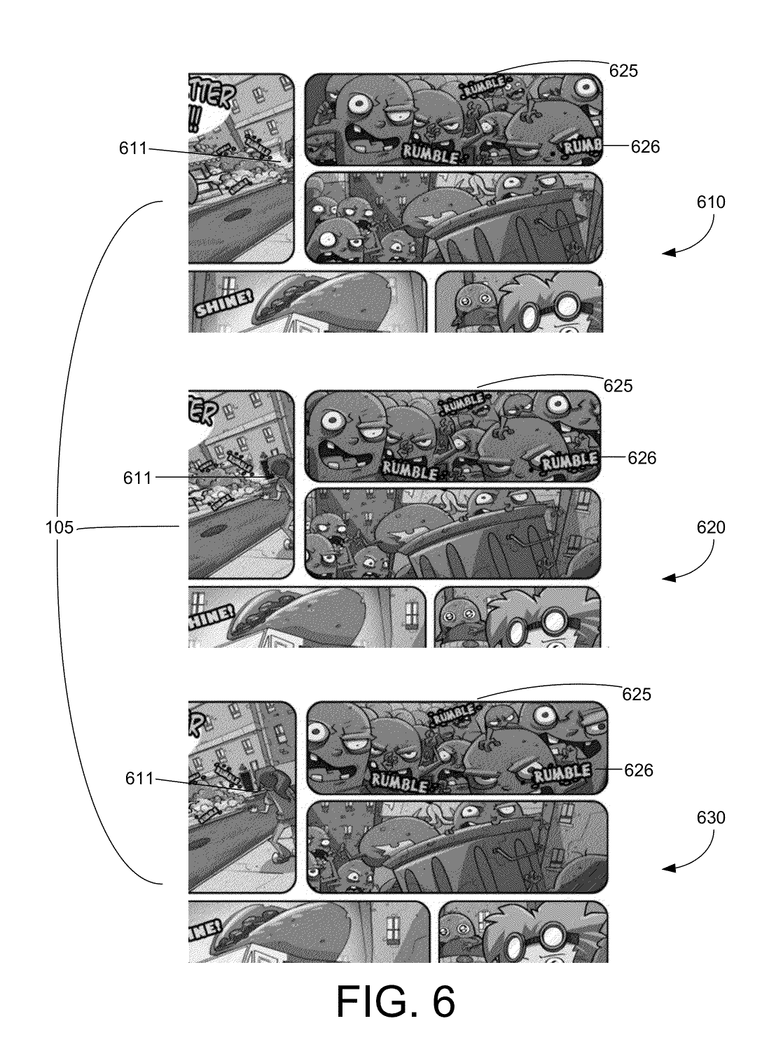

FIG. 6 provides an exemplary embodiment of a three-dimensional digital image 105 resulting from an exemplary embodiment method for providing a three-dimensional display of a digital image 190. In this exemplary embodiment, figures 610, 620, and 630 illustrate different perspectives of the same digital image 105 as modified by an exemplary embodiment of the current invention: 3D MotionView™. In this exemplary embodiment, multiple layers of a digital image stack upon one another. In this exemplary embodiment, each layer may contain a percent of transparency ranging from 0-99%. The percent of transparency, in this exemplary embodiment, relies, at least partially, upon a device enabled to provide spatial orientation data between the display 110 and observer. For further example, and not limitation, the exemplary embodiment, 3D MotionView™, creates digital image 105 to be displayed on a smartphone. The exemplary embodiment, 3D MotionView™, is enabled to receive spatial orientation data regarding the spatial orientation of the smartphone from an accelerometer in the smartphone. In this exemplary embodiment, the accelerometer sends spatial orientation data to the three-dimensional parallax display module of exemplary embodiment 3D MotionView™ based on the viewer's movement of the smartphone. Thus, allowing the exemplary embodiment to modify the various layers of the image displayed to illustrate individual horizontal and vertical movement and provide three-dimensional depth to the display 100 on the smartphone.

FIG. 6 illustrates an exemplary embodiment of the method for providing a three-dimensional display of a digital image 190. In this exemplary embodiment, images 610, 620, and 630 demonstrate, for example, and not limitation, quantized screenshots from a three-dimensional parallax display 100. Perspective of images in this exemplary embodiment corresponds, respectively, with rotation A, B, and C. Element 611 of this exemplary embodiment demonstrate a character cropped into digital image 105 as the smartphone rotates. Additionally, element 725 of this exemplary embodiment demonstrate that text layers remain in the same position. Furthermore, element 726 of this exemplary embodiment illustrate that text, though given a high resistance, can be cropped into and out of a digital image as the electronic device rotations.

While the invention has been disclosed in its exemplary forms, it will be apparent to those skilled in the art that many modifications, additions, and deletions can be made therein without departing from the spirit and scope of the invention and its equivalents as set forth in the following claims.

What we claim is:

1. A method for providing a three-dimensional display of a digital image comprising:
retrieving at least one digital image from a storage memory of an electronic device, wherein the digital image comprises at least two digital image layers;
displaying to a viewer the at least two digital image layers of the digital image;
estimating a change in a perspective of the viewer by a three-dimensional display module based on a plurality of spatial orientation data; and
modifying, with the three-dimensional parallax display module, the display of the at least two digital image layers.

2. A method for providing a three-dimensional display of a digital image of claim 1, wherein the three-dimensional parallax display module modifies the display by modifying the arrangement of the at least two digital image layers.

3. A method for providing a three-dimensional display of a digital image of claim 1, wherein the three-dimensional parallax display module modifies the display the at least two digital image layers in accordance with the change in the perspective of the viewer based on the plurality of spatial orientation data.

4. A method for providing a three-dimensional display of a digital image of claim 1, wherein the three-dimensional parallax display module modifies the display of the digital image by altering a translation amount and a transparency amount of the at least two digital image layers.

5. A method for providing a three-dimensional display of a digital image of claim 1, wherein the three-dimensional parallax display module modifies the display of the digital image by altering bleed amount.

6. A method for providing a three-dimensional display of a digital image of claim 1, wherein the plurality of spatial orientation data is obtained from a sensor.

7. A method for providing a three-dimensional display of a digital image of claim 6, wherein the sensor is an accelerometer.

8. A method for providing a three-dimensional display of a digital image of 1, wherein the three-dimensional parallax display module is a separate from the electronic device.

9. A three-dimensional parallax display device comprising:
an electronic device comprising a processor, a storage memory, and a display for displaying one or more digital images, wherein each digital image is comprised of at least two digital image layers; and
three-dimensional parallax display module enabled to analyze a plurality of spatial orientation data and enabled to modify the display of the at least two digital image layers.

10. A three-dimensional parallax display device of claim 9, wherein a plurality of spatial orientation data is collected from a sensor.

11. A three-dimensional parallax display device of claim 9, wherein the three-dimensional parallax display module analyzes a plurality of spatial orientation data collected from an accelerometer.

12. A three-dimensional parallax display device of claim 9, wherein the electronic device is a smartphone.

13. A three-dimensional parallax display device of claim 9, wherein the three-dimensional parallax display module converts the plurality of spatial orientation data into one or more vectors.

14. A three-dimensional parallax display system comprising:
a display for displaying one or more digital images, wherein each digital image is comprised of at least two digital image layers; and
a three-dimensional parallax display module enabled to modify the display of the at least two digital image layers, wherein modification of the one or more digital image layers is dependent upon a plurality of spatial orientation data.

15. A three-dimensional parallax display system of claim 14, wherein the plurality of spatial orientation data is collected from a sensor.

16. A three-dimensional parallax display system of claim 15, wherein the sensor is a gyroscope.

17. A three-dimensional parallax system of claim 14, wherein the plurality of spatial orientation data is obtained from a video game controller.

18. A three-dimensional parallax system of claim 14, wherein the display is a television.

19. A three-dimensional parallax system of claim 14, wherein the three-dimensional display processing unit is a computer.

20. A three-dimensional parallax system of claim 14, further comprising a wireless transceiver, wherein a plurality of spatial orientation data is received via the wireless transceiver.
